(19) United States
(12) Patent Application Publication
(10) Pub. No.: US 2006/0195892 A1
(43) Pub. Date: Aug. 31, 2006

(54) Appointed meeting system, management device and appointed meeting method

(75) Inventor: Yoshiyuki Inage, Kawasaki (JP)

Correspondence Address: STAAS & HALSEY LLP;JIM LIVINGSTON, SUITE 700, 1201 NEW YORK AVENUE, N.W., WASHINGTON, DC, 20005, US

(73) Assignee: Fujitsu Limited, Kawasaki (JP)

(21) Appl. No.: 11/235,353

(22) Filed: Sep. 27, 2005

(30) Foreign Application Priority Data
Feb. 28, 2005 (JP) JP2005-054801

(51) Int. Cl. H04L 9/32

(52) U.S. Cl. 726/5

(57) ABSTRACT

To provide a technology of acquiring, if unable to conduct an appointed meeting of a plurality of persons as scheduled, situations of the individual persons and easily notifying each member of a change of the appointed meeting corresponding to the situations. Member information of members making arrangements for an appointed meeting and appointed meeting conditions are received from an inquirer terminal, a member situation query message based on the member information is sent to the inquired device, member situation information is received from the inquired terminal, and appointed meeting information is obtained based on the situation information and the appointed meeting conditions and transmitted to the inquired terminal and the inquirer terminal.

### BACKGROUND OF THE INVENTION

The invention relates to a technology of communicating with individual persons on the occasion of making arrangements for an appointed meeting among a plurality of persons.

As a method of checking schedules of a plurality of persons, there has hitherto been a method involving the use of so-called GroupWare, wherein the individual persons register their schedules in a server, and timetables of the individuals can be referred to via a network. In this case, however, a possible-of-grasping schedule is the schedule registered beforehand by each person, and the schedule can not be grasped in real-time including even a case an unscheduled situation occurs such as a case of forgetting the schedule, a case of being behind the scheduled time and so on. If such a situation occurs, it is general to gain confirmation from the individuals by phone.

Further, a means for communicating with the plurality of persons is a method involving the use of a multicast mail.

Moreover, the prior art related to the application of the invention is, for example, a technology disclosed in Patent document 1 that follows.

[Patent document 1]

Japanese Patent Application Laid-Open No.2002-175255

### SUMMARY OF THE INVENTION

To be specific, an assembly is scheduled to be held, if all the members do not yet assemble even when reaching the start time, and what can be checked through a schedule table is limited to the timetables of the individual members.

For checking situations of the not-yet-assembled persons and determining measures to be taken thereafter, it is checked how late each person arrives by individually communicating by phone, a change of the assembly is thereafter determined such as postponing or canceling the assembly in accordance with the delay thereof, and each person is informed of this change by phone on another occasion, resulting in a problem that the handling operation becomes extremely troublesome.

Further, it is also considered that the queries about the situations are sent at one time by the multicast mails, however, a problem even in this case arises, wherein as answers are respectively sent back, the situation of the individual is confirmed by checking the mail received each time, and thereafter a mail describing the postponement, cancellation, etc. of the assembly is created and then retransmitted, with the result that the handling operation is still troublesome.

Such being the case, the invention provides a technology of acquiring, if unable to conduct an appointed meeting of a plurality of persons as scheduled, situations of the individual persons and easily notifying each member of a change of the appointed meeting corresponding to the situations.

For obviating the problems, the invention adopts the following configurations.

Namely, an appointed meeting system according to the invention includes an inquirer device, an inquired device and a management device (server) that are connected via a network, the management device comprises a condition receiving module for receiving member information about members making arrangements for an appointed meeting and appointed meeting conditions from an inquirer device, a query module for sending a member situation query message based on the member information to an inquired device, a situation receiving module for receiving member situation information from the member device, an appointed meeting determining module for obtaining the appointed meeting information on the basis of the situation information and the appointed meeting conditions, and an appointed meeting communication module for transmitting the appointed meeting information to the member devices, the inquirer device comprises a condition transmitting module for transmitting the member information and the appointed meeting conditions to the management device, and the inquired device comprises a query receiving module for receiving a member situation query message, a situation transmitting module for transmitting the member situation information to the management device, and an appointed meeting information receiving module for receiving the appointed meeting information.

Further, according to the invention, there is provided an appointed meeting method by which a computer executes a step of receiving member information about members making arrangements for an appointed meeting and appointed meeting conditions from an inquirer device, a step of sending a member situation query message based on the member information to the inquired, a step of receiving member situation information from the inquired device, a step of obtaining the appointed meeting information on the basis of the situation information and the appointed meeting conditions, and a step of transmitting the appointed meeting information to the member devices.

In the appointed meeting system and the appointed meeting method, when receiving points of time as pieces of situation information till a plurality of members arrive, among the points of time till their arrivals, anyone of the latest time, the latest time that does not exceed predetermined time, the time till an arrival of a predetermined member, the time when a predetermined number of members arrive and the time when a predetermined percentage of members arrive, may be determined as appointed meeting time.

In the appointed meeting system and the appointed meeting method, when receiving attendance and absence of the plurality of members as the situation information, with respect to the attendance and the absence of the members, if the predetermined member is absent, the appointed meeting may be determined to be canceled or postponed.

In the appointed meeting system and the appointed meeting method, when receiving the points of time till the plurality of members arrive and/or their present locations as the member situation information, an appointed meeting place may be determined based on the situation information.

Further, the invention may also be a program (appointed meeting program) for making a computer execute the appointed meeting method. Moreover, the invention may also be a readable-by-computer storage medium stored with the appointed meeting program. The computer is made to read and execute the program on this recording medium, whereby functions thereof can be provided.

Herein, the readable-by-computer storage medium connotes a storage medium capable of storing information such as data, programs, etc. electrically, magnetically, optically, mechanically or by chemical action, which can be read from the computer. Among these storage mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the storage mediums fixed within the computer.

According to the invention, it is possible to provide a technology of acquiring, if unable to conduct an appointed meeting of a plurality of persons as scheduled, situations of the individual persons and easily notifying each member of a change of the appointed meeting corresponding to the situations.

### BRIEF DESCRIPTION OF THE DRAWINGS

FIG. 1 is a schematic view of an appointed meeting system according to the invention.

FIG. 2 is a schematic diagram of a server according to the invention.

FIG. 3 is a schematic diagram of an inquired device and an inquirer device.

FIG. 4 is an explanatory diagram of a top page on a Web site.

FIG. 5 is an explanatory diagram of a registration page.

FIG. 6 is an explanatory diagram of a registered person list page.

FIG. 7 is an explanatory diagram of an appointed meeting method.

FIG. 8 is an explanatory diagram of a page used for selecting a recipient.

FIG. 9 is an explanatory diagram of an appointed meeting condition setting page.

FIG. 10 is an explanatory diagram of the appointed meeting condition setting page.

FIG. 11 is an explanatory diagram of a page used for checking a transmission content.

FIG. 12 is a diagram showing an example of a mail for notifying of a link to an input page.

FIG. 13 is an explanatory diagram of a page used for checking the transmission.

FIG. 14 is an explanatory diagram of a page used for inputting answers.

FIG. 15 is a diagram showing an example of a mail to be sent to each member.

FIG. 16 is a diagram showing an example of a mail to be sent to each member.

FIG. 17 is an explanatory diagram of a page used for displaying a state of answers.

FIG. 18 is an explanatory diagram of a page used for displaying the state of answers.

FIG. 19 is an explanatory diagram of an appointed meeting condition setting page in a modified example 1.

FIG. 20 is an explanatory diagram of the appointed meeting condition setting page in a modified example 2.

FIG. 21 is an explanatory diagram of the appointed meeting condition setting page in a modified example 3.

### DETAILED DESCRIPTION OF THE PREFERRED EMBODIMENT

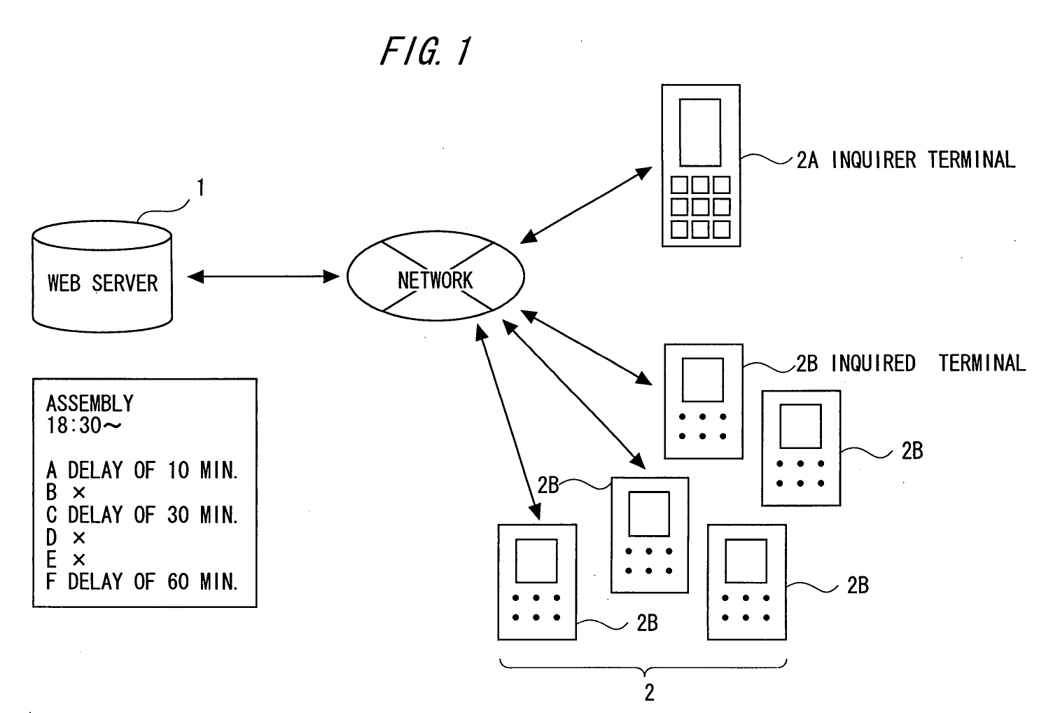

FIG. 1 is a schematic view of an appointed meeting system according to the invention.

As shown in FIG. 1, an appointed meeting system 10 in this example includes a Web server 1 (corresponding to a management device) and member terminals (cellular phones) 2 which are connected (to each other) via a network such as the Internet, a cellular phone line, etc.

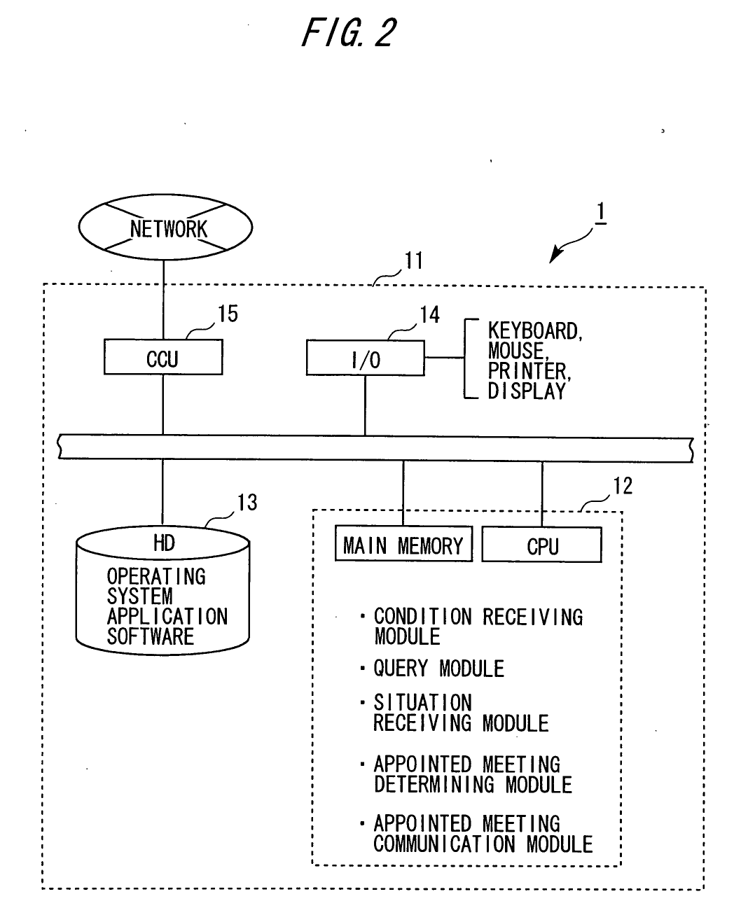

FIG. 2 is a schematic diagram of a configuration of the Web server 1 in the embodiment. As shown in FIG. 2, the Web server 1 is a general type of computer having a main body 11 equipped inside with an arithmetic processing unit 12 constructed of a CPU (Central Processing Unit), a main memory, etc., a storage unit (hard disc) 13 stored with data and software for arithmetic processing, I/O ports 14, a communication control unit (CCU) 15 and so on.

Input devices such as a keyboard, a mouse, a CD-ROM drive, etc., and output devices such as a display device, a printer, etc., are properly connected to the I/O ports 14.

The CCU 15 performs communications with other computers (which are the cellular phones 2 in this example) via the network.

The storage unit 13 is preinstalled with an operating system (OS) and application software (an appointed meeting program).

The arithmetic processing unit 12 properly reads the OS and the application program from the storage unit 13, then executes the OS and the application program, and effects arithmetic processing upon pieces of information inputted from the I/O ports 14 and from the CCU 15 and the information read from the storage unit 13, thereby functioning also as a condition receiving module, a query module, a situation receiving module, an appointed meeting determining module and an appointed meeting communication module.

This condition receiving module receives pieces of member information about members who make arrangements for the appointed meeting and appointed meeting conditions from the cellular phones 2.

The query module sends a query message about a situation of each member on the basis of the member information.

The situation receiving module receives the member situation information from the cellular phones 2.

The appointed meeting determining module obtains the appointed meeting information on the basis of the situation information and the appointed meeting condition. For example, in the case of receiving points of time up to arrivals as pieces of situation information about the plurality of members, among these points of time up to their arrivals, the latest time, the latest time that does not exceed a predetermined time range, the time up to an arrival of a predetermined member, the time when a predetermined number of members arrive and the time when a predetermined percentage of members arrive, are determined as the appointed meeting time, and comments associated with the appointed meeting time are read from the storage unit 13 and set as the appointed meeting information.

The appointed meeting communication module sends the appointed meeting information to the cellular phones 2.

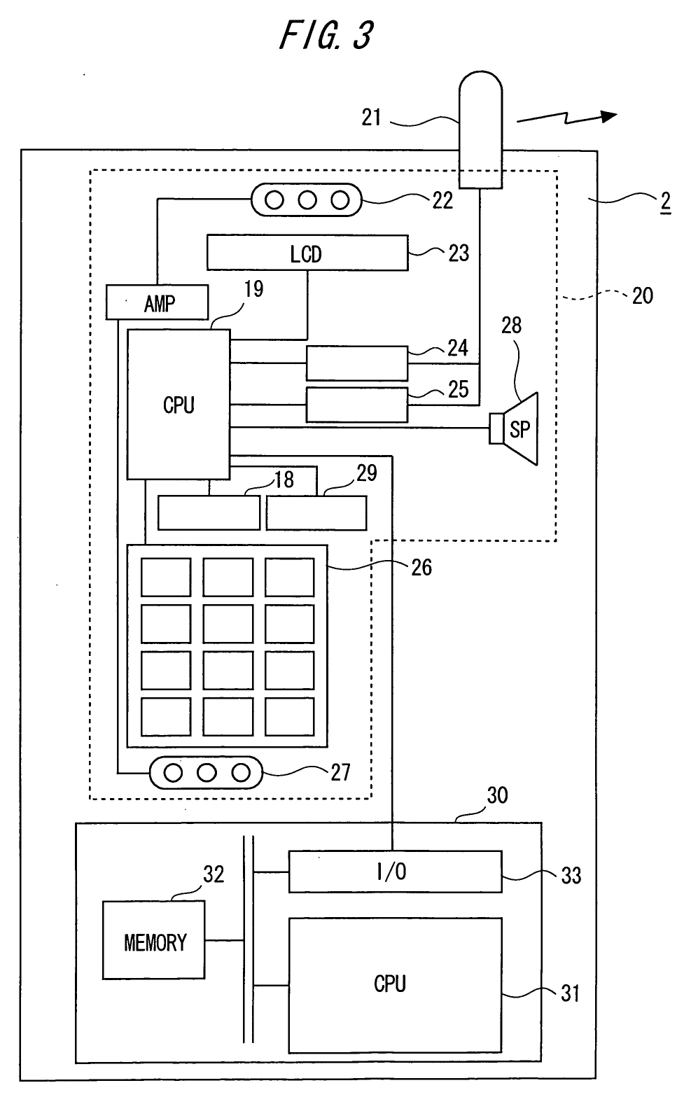

On the other hand, FIG. 3 is a block diagram of the member terminal (which is the cellular phone in this example) 2 corresponding to an inquirer device and an inquired device according to the present invention.

The cellular phone 2 has a basic modular unit 20, mainly for talking (conversation), including a memory 18, a CPU 19, an antenna 21, a receiving speaker 22, a display unit (LCD) 23, a transmitting unit 24, a receiving unit 25, an operation unit 26, a microphone 27, a loudspeaker 28, a vibrator 29 and so on.

When a user operating the operation unit 26 and gives an instruction of calling by reads a phone number of a partner terminal (cellular phone) from the memory 18, the CPU 19 connects to the phone of the partner terminal via a telephone network of a base station, etc., in a way that controls the respective components, thereby enabling the conversation on the phone. At this time, for example, the transmitting unit 24 encodes a user's voice inputted from the microphone 27 into transmission signals and transmits the transmission signals as carried on radio waves to the base station from the antenna 21. Moreover, the receiving unit 25, receives the transmitting signals of the phone of the partner terminal from the base station, then encodes the transmission signals into voice signals, and outputs the voice signals from the receiving loudspeaker 22.

Further, the cellular phone 2 has an extended modular unit 30 including a CPU 31, a memory 32 and an I/O 33.

The CPU 31 reads a communication control program stored on the memory (corresponding to a storage unit) 32, and executes processing based on this program, thereby actualizing functions of a condition transmitting module, a query receiving module, a situation transmitting module and an appointed meeting information receiving module.

This condition transmitting module transmits the member information and the appointed meeting condition to a server.

The query receiving module receives a query message about a situation of the member.

The situation transmitting module transmits the situation information of the member to the sever 1.

The appointed meeting information receiving module receives the appointed meeting information from the Web server 1.

Note that the embodiment has exemplified the example in which the inquirer device and the inquired terminal are constructed of the same terminal and can be utilized as both of the inquirer device and the inquired device, and may also be, without being limited to this configuration, a separated configuration into an inquirer device including the condition transmitting module and an inquired device including the query receiving module, the situation transmitting module and the appointed meeting information receiving module. Moreover, the inquirer device and the inquired device may be, without being limited to the cellular phones, devices such as PDAs (Personal Digital Assistants), personal computers, etc. capable of actualizing the functions of the respective modules.

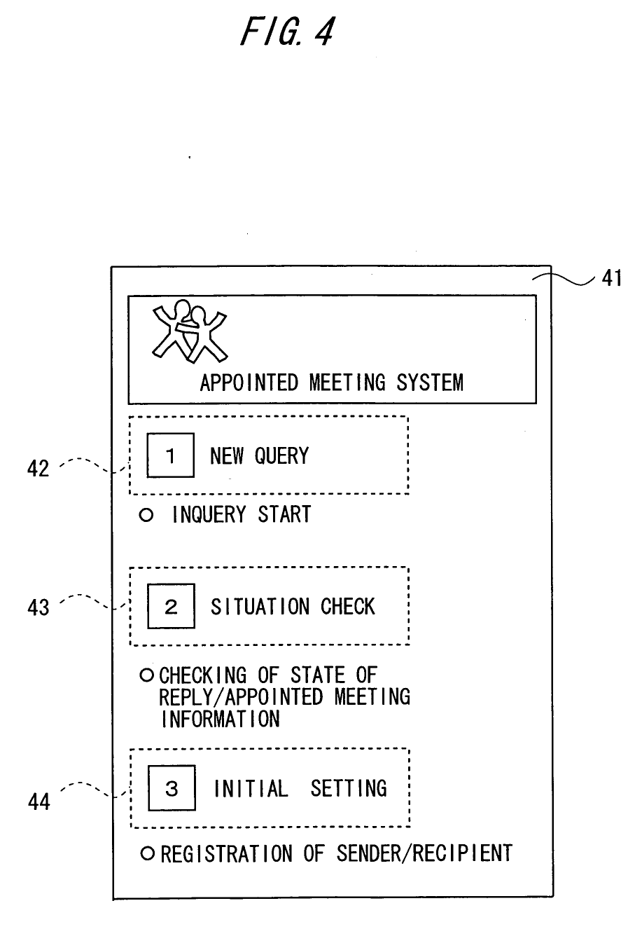

Next, an appointed meeting method executed in the system 10 will be explained with reference to FIGS. 4 through 21. Note that a discussion in the case of distinguishing between the inquirer (sender) terminal and the inquired (recipient) terminal will be made in such a way that, as shown in FIG. 1, a cellular phone 2A serves as the inquirer terminal, and a cellular phone 2B serves as the inquired (recipient) terminal.

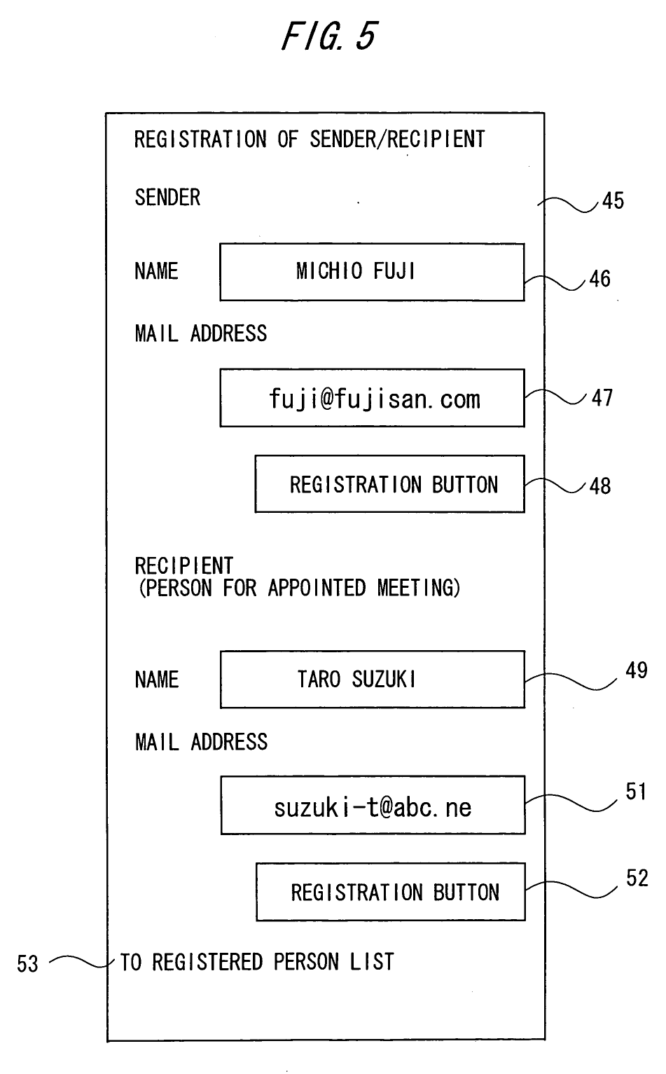

When the cellular phone 2A accesses the server 1 through an operation of the inquirer, the server 1 provides the cellular phone 2A with a top page of a Website and prompts the cellular phone 2A to display the top page. FIG. 4 shows an example of this top page. On this top page 41, when initial setting 44 is selected, the server 1 provides a sender/recipient registration screen 45 as shown in FIG. 5.

When the inquirer (sender) inputs (enters) a sender's own name and a mail address thereof respectively into a sender name box 46 and a mail address box 47 and selects a registration button 48, the cellular phone 2A transmits this item of sender information to the server 1. Similarly when the inquirer inputs a name and a mail address of the appointed meeting partner (recipient) respectively into a recipient name box 49 and a mail address box 51 and selects a registration button 52, the cellular phone 2A transmits these pieces of recipient information to the server 1. Then, the registrations of the names and the mail addresses of a required number of recipients are repeatedly made.

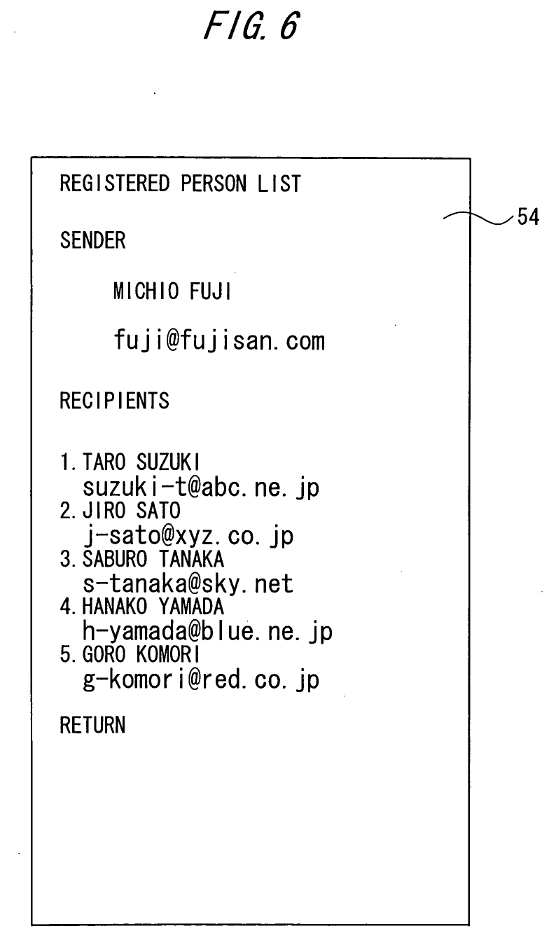

The server 1 receives and registers these pieces of sender/recipient information on the storage unit 13 and, when a link 53 to a registered user list on a registration screen 45 is selected, the cellular phone 2 is provided with a registered user list screen 54 as shown in FIG. 6.

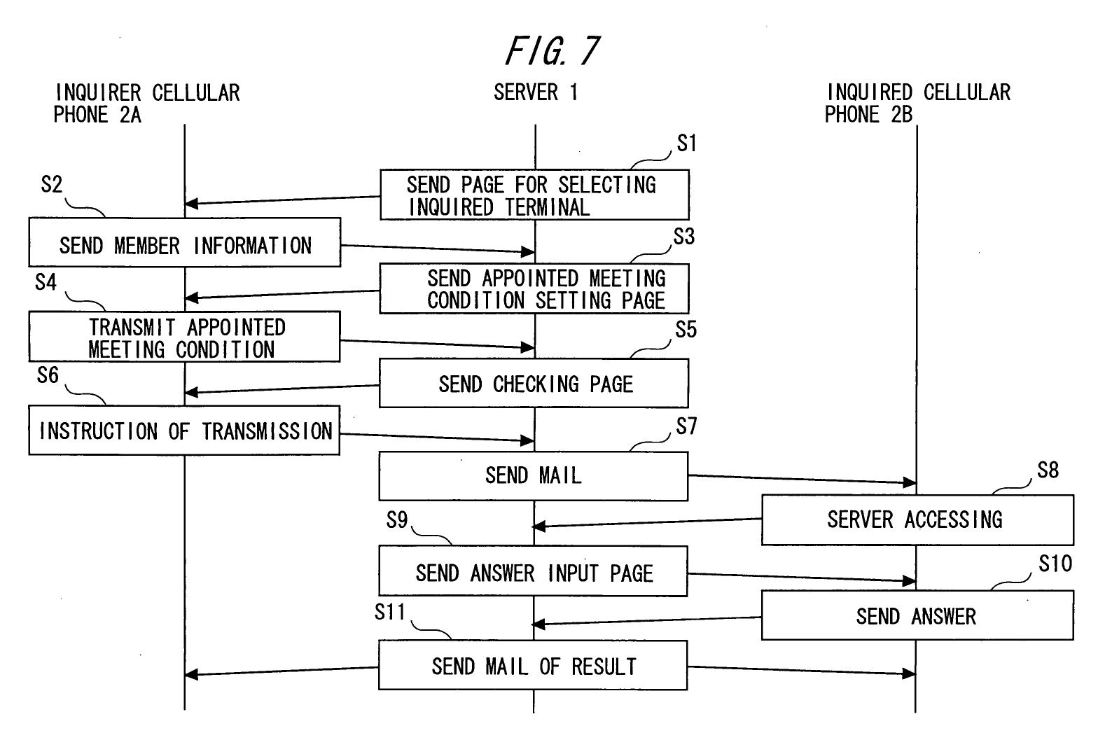

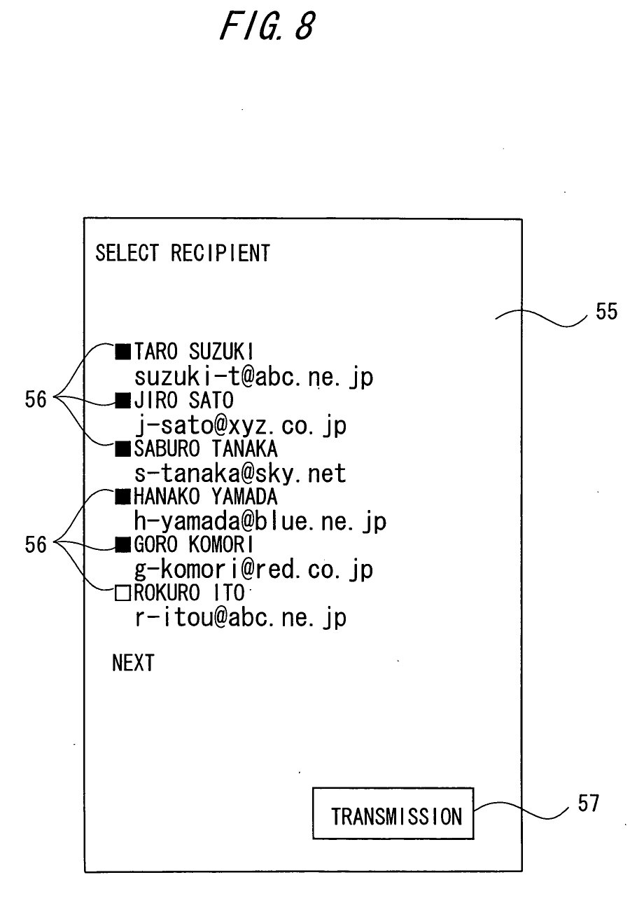

Then, when the inquirer selects a new query 42 from the top page 41, the server 1 executes the appointed meeting method as shown in FIG. 7. To begin with, the server 1 reads the sender/recipient information stored beforehand on the storage unit 13 in accordance with identifying information, e.g., the phone number and Cookie of the cellular phone that selected the new query 42, then specifies the name of the inquirer and the mail address of the inquirer device, generates an inquired terminal selection page 55 as shown in FIG. 8, transmits the selection page 55 to the cellular phone 2A and prompts the cellular phone 2A to display this selection page 55 (step 1, which will hereinafter be abbreviated such as S1).

When the inquirer selects a check box 56 of the recipient as the inquired terminal in the list of this page 55 and then selects a transmission button 57, the cellular phone 2A sends, through the function of the condition transmitting module, the selected recipient information as the member information to the server 1 (S2).

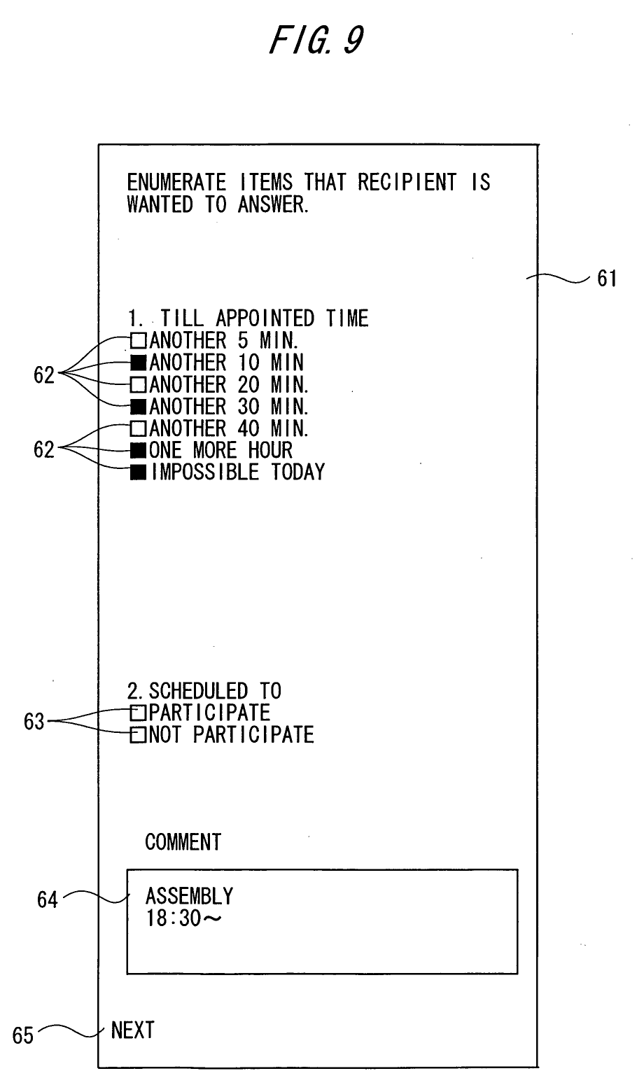

The server 1 stores the received member information on the storage unit 13 and sends, to the cellular phone 2A, appointed meeting condition setting pages 61, 66 as shown in FIG. 9-11 (S3).

When the inquirer inputs the appointed meeting conditions in accordance with the pages 61, 66, the cellular phone 2A sends the appointed meeting conditions to the server 1 through the function of the condition transmitting module (S4). To be specific, when the inquirer selects a check box 62 or 63 corresponding to an item that the recipient is wanted to answer on the page 61 in FIG. 9, then inputs a comment for the recipient into a comment box 64 and selects a link 65 to a next page, the cellular phone 2A sends the answer items and the comment information as the query information to the server 1 through the function of the condition transmitting module.

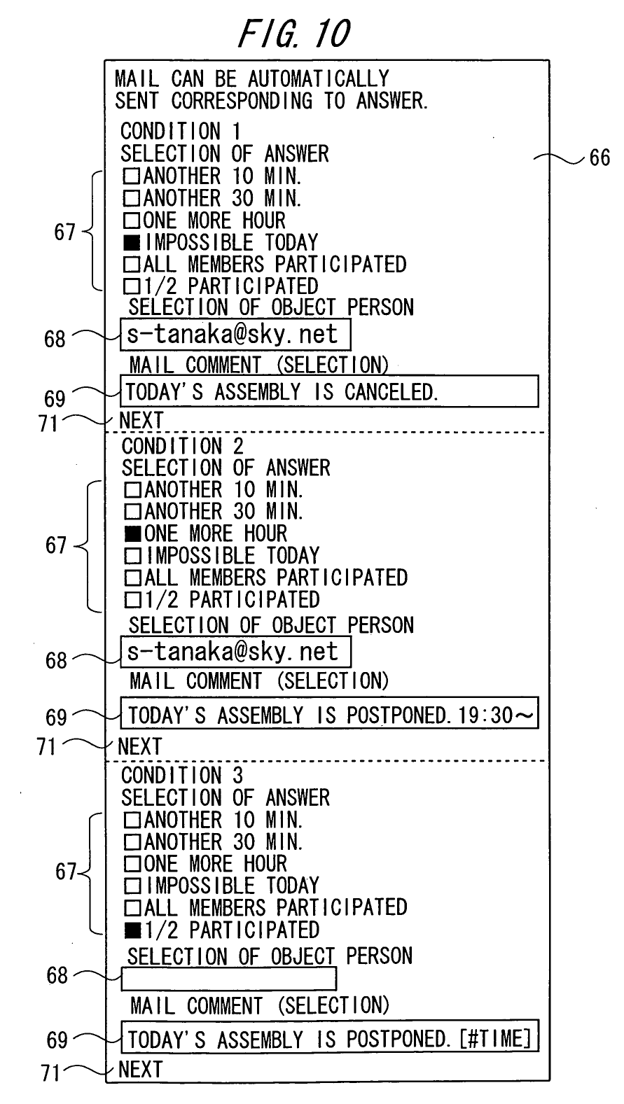

The server 1 stores the received query information on the storage unit 13, then generates a condition input page 66 of conditions as shown in FIG. 10 with respect to the answer items on the basis of the query information, and sends the page 66 to the cellular phone 2A.

The inquirer inputs conditions for automatically transmitting a mail in response to the answer from the recipient through the page 66. Namely, the inquirer checks a check box 67 for the answer items in which the conditions are set (a blackened square box represents the selected check box in FIG. 10), inputs an address of an object person into an object person selection box 68, and inputs into a comment box 69 a comment that is sent to the recipient. After inputting these conditions, when a link 71 to a next page is selected, the cellular phone 2A transmits these pieces of information as the condition information to the server 1.

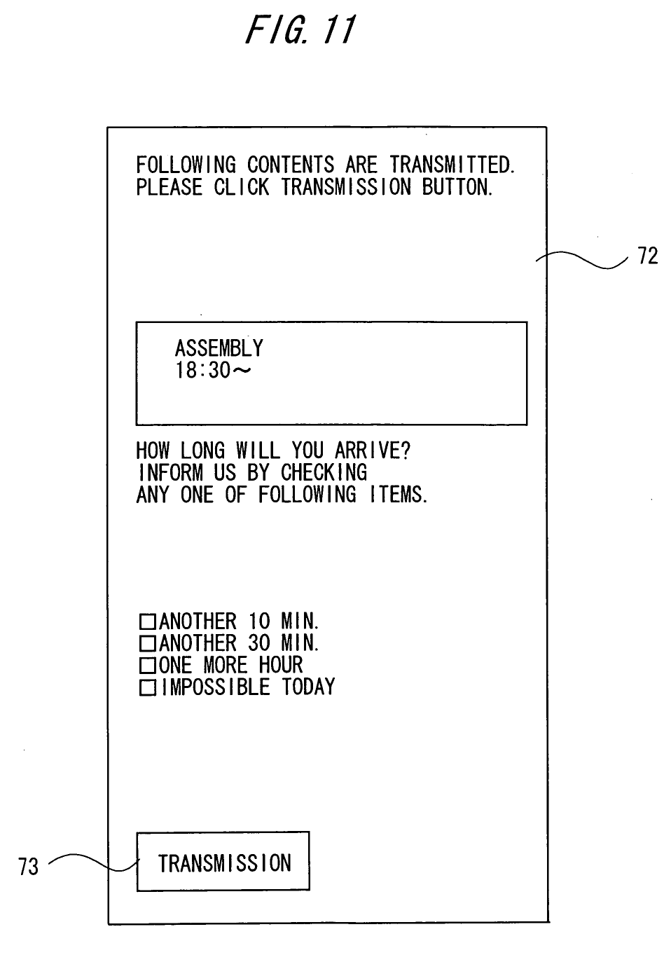

The sever 1 stores the storage unit 13 with the query information and the condition information as the appointed meeting conditions, then generates a page 72 for checking comments to be sent to the recipient and query items as shown in FIG. 11 on the basis of the query information, and sends the page 72 to the cellular phone 2A (S5).

When the inquirer confirms this page 72 and selects a transmission button 73, the cellular phone 2A sends a transmission instruction to the server 1 (S6).

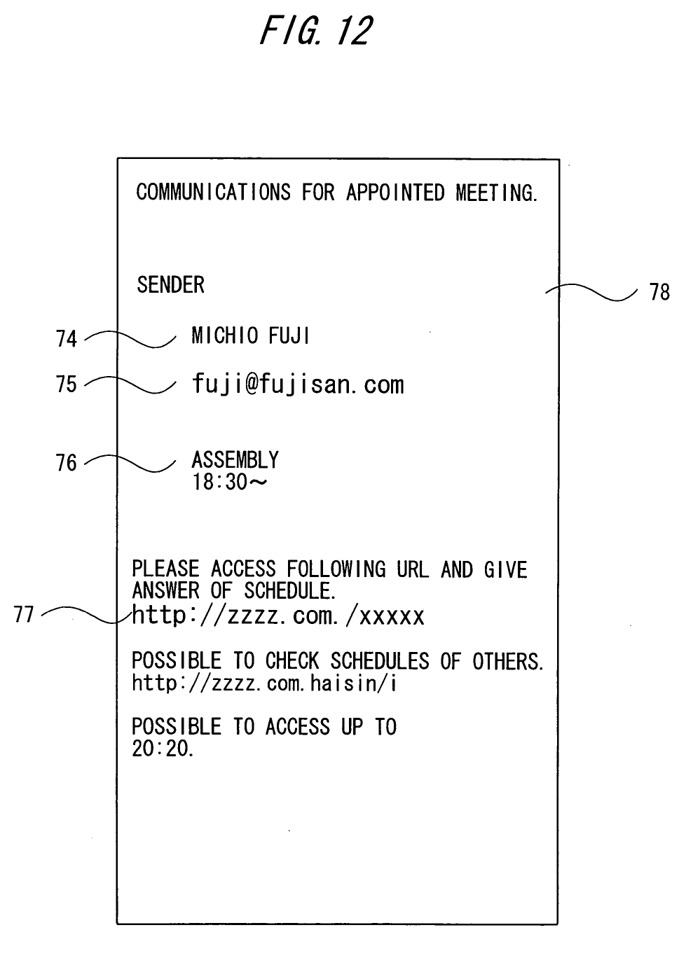

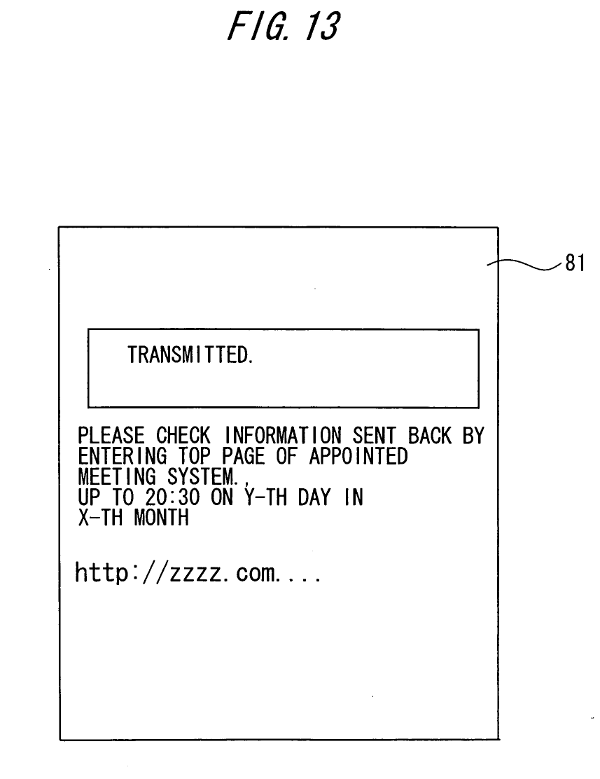

The server 1, when receiving this transmission instruction, sends an electronic mail 78 describing an inquirer name, an inquirer device address 75, a comment 76 for the recipient and a link 77 to the answer item input page as shown in FIG. 12 to the mail address of each recipient on the basis of the member information (S7). Along with this, the sever 1 sends an electronic mail 81 showing a purport of having transmitted as shown in FIG. 13 to the cellular phone 2A.

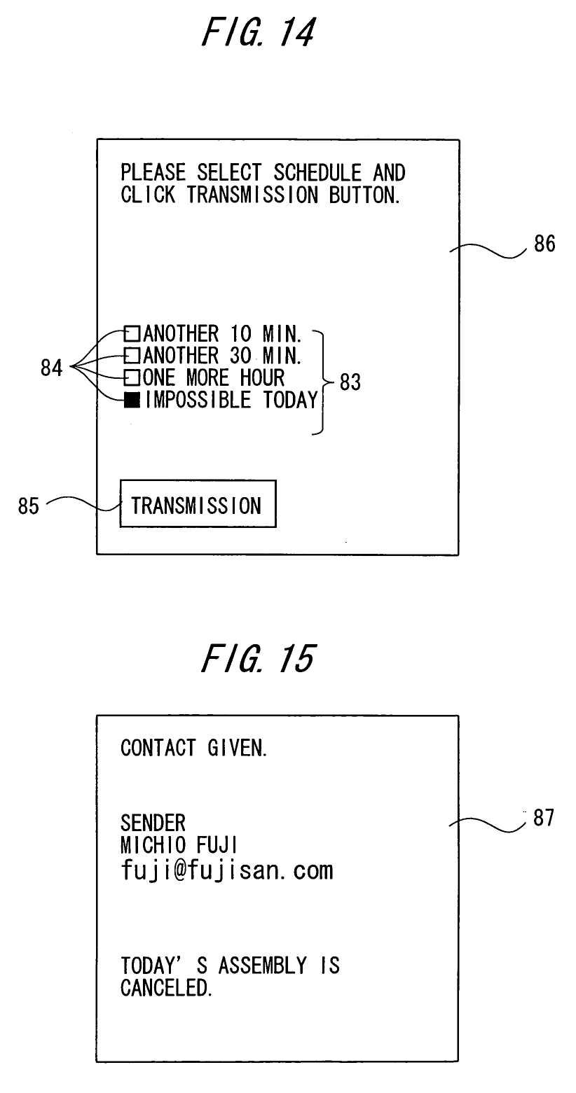

Then, when the recipient selects the link 77 of this electronic mail 78, each cellular phone 2B accesses the server 1 (S8). Responding to this, the server 1 sends a schedule input page 86 as shown in FIG. 14 to the cellular phone 2B (S9). Note that in this example, the server 1, on the occasion of creating this mail 78, adds the identifying information (the mail address) of the recipient to this link 77, where by the server 1 can recognize (identify) which cellular phone 2B the access is gained from.

When the recipient selects any one of check boxes 84 showing answer items 83 and chooses a transmission button 85, the cellular phone 2B sends the information of the selected answer to the server 1 (S10).

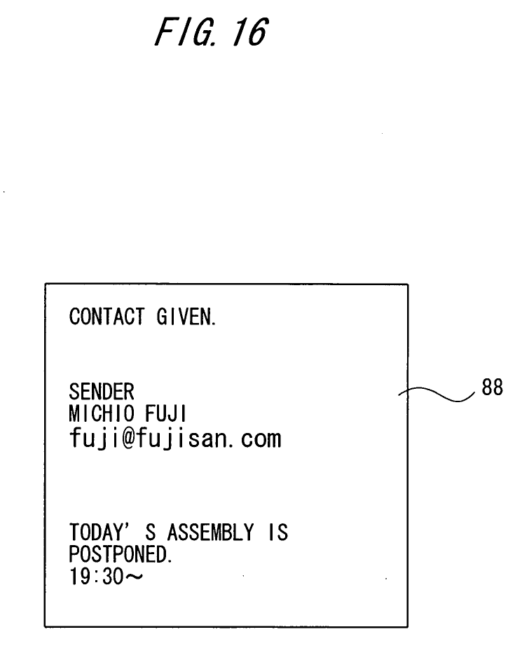

The server 1, in the case of receiving the answer information from each cellular phone 2B, refers to the appointed meeting conditions stored on the storage unit 13, creates a response mail corresponding to the appointed meeting conditions and sends the mail to each cellular phone 2 (S11). For instance, if the conditions 1 through 3 shown in FIG. 10 are set, and if an answer “Impossible today” is received from the member having an address “s-tanaka@sky.net”, this conforms with the condition 1, and hence the server 1 creates a mail 87 (FIG. 15) in which the text has insertion of a comment such as [Today's assembly is canceled.] and sends the mail 87 to the cellular phones 2A and 2B of the individual members. Similarly, if an answer “It will take one more hour” is received from the member having the address “s-tanaka@sky.net”, this conforms with the condition 2, and therefore the server 1 creates a mail 88 (FIG. 16) in which the text has insertion of a comment such as [Today's assembly is postponed to 19:00-] and sends the mail 88 to the cellular phones 2A and 2B of the individual members. Further, in the case of receiving answers such as “It will take another 10 minutes”, “It will take another 30 minutes”, “It will take one more hour” and “Impossible today”, the server 1 creates a mail in which the text has insertion of a comment in accordance with the condition 3, and sends the mail to the cellular phones 2A and 2B of the individual members. In this case, the time when the majority of the members will arrive is obtained and inserted into [#TIME] in the comment in the condition 3. Namely, in the example, this goes such as [Today's assembly is postponed and will be held 30 minutes later.]. Note that priority levels are previously determined in the respective conditions 1-3, and, if the answer results from the individual members meet a plurality of conditions, the condition exhibiting the higher priority level is applied. For example, in this example, the higher priority level is set in the condition set earlier, i.e., the condition having the smaller number. With this contrivance, if a key person (Tanaka) is absent (i.e., the case of meeting the condition 1), it is possible to set so that the assembly is canceled even when the majority of the members can participate (the case of meeting the condition 3).

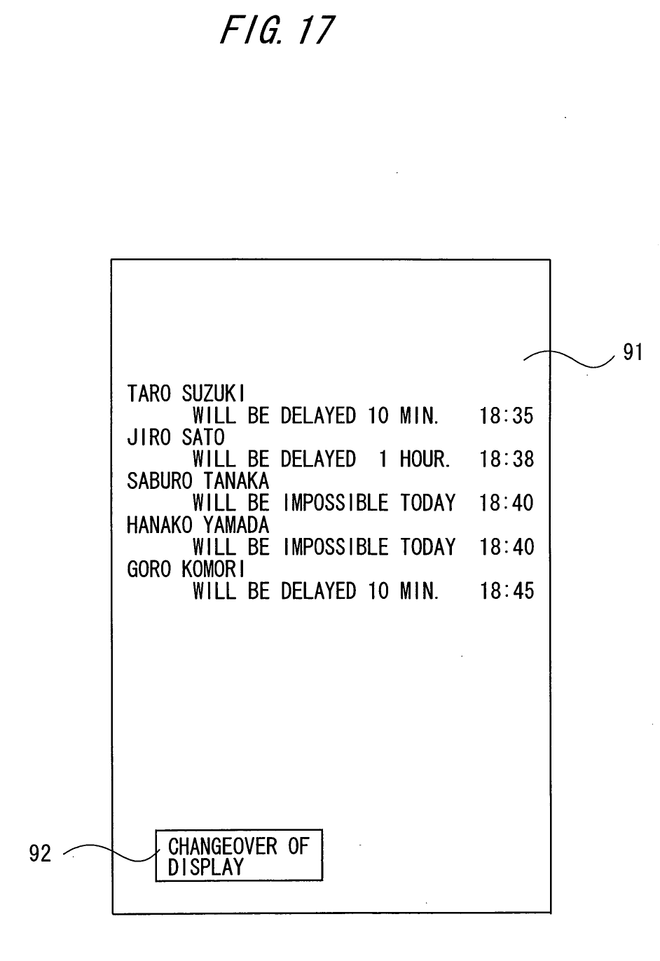

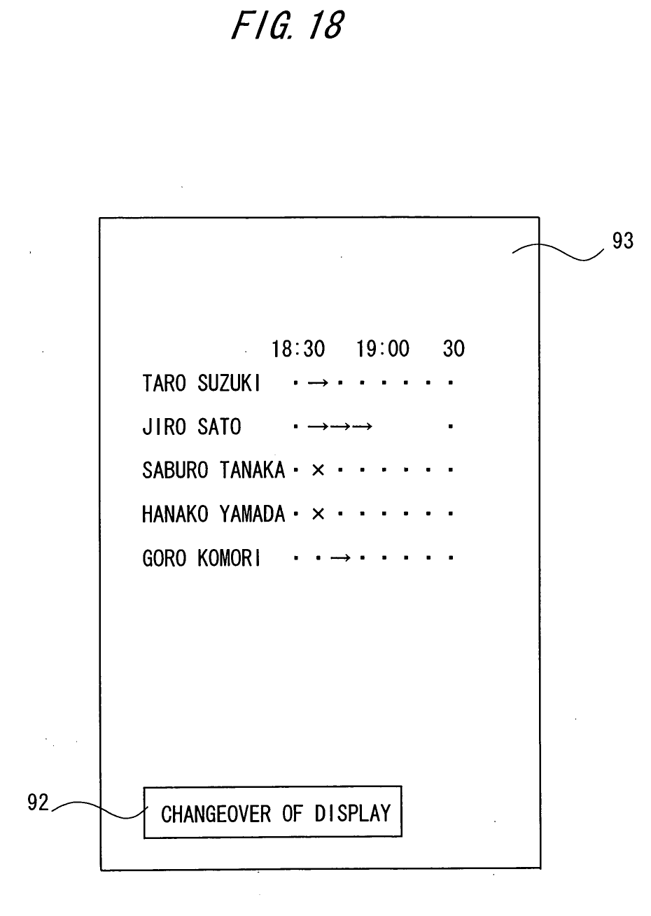

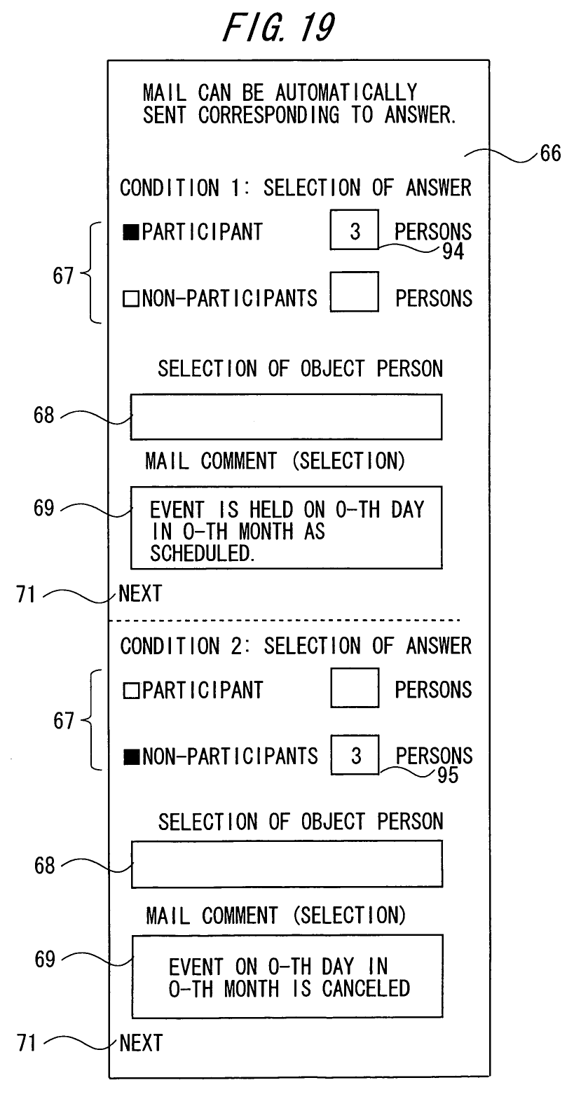

Moreover, when each member selects a situation check 43 from the top page 41 in FIG. 4, the cellular phone 2 requests the server 1 for a situation check page, and the server 1 reads the name of each recipient and the answer from the storage unit 13, then creates a page 91 describing these pieces of information and sends the page 91 to the requester cellular phone 2. Note that display formats of the information of this situation check may be mutually changed over as seen on the page 91 in FIG. 17 and on the page 93 in FIG. 18 by selecting a display change over button 92.

According to the embodiment as described above, if unable to conduct the assembly of the plurality of members as scheduled, it is possible to obtain the situations of the individual members and to automatically notify the individual members that the assembly start time is changed or the assembly is canceled corresponding to the situations by the mail.

Incidentally, the appointed meeting system in the embodiment can be utilized for a variety of arrangements for the appointed meeting as below by changing the appointed meeting conditions and the answer options without being limited to the communications for the assembly.

### MODIFIED EXAMPLE 1

### Example for Checking Whether Event Participants Reach Minimum Number of Participants for Conducting Event

For instance, after selecting the recipients in the same way as the above-mentioned, a check box 63 for participation or non-participation is selected on the condition selection page 61 in FIG. 9, and there is inputted such as [Please inform us as to whether you participate in the event held on the o-th day in o-th month.].

Then, on a condition selection page 66 in FIG. 19, a participation check box 67 is checked in the condition 1, the minimum number of participants for conducting the event is inputted into a number-of-participants box 94. Then, in the condition 2, the check box 67 for the non-participation is checked, and the number of participants for canceling the event is inputted into a number-of-participants box 95. Note that the following operations are the same as the above-mentioned.

With this operation, according to the conditions 1 and 2, the server 1 receiving the answer from the cellular phone 2B of each member, as the condition 1 is met if there are three or more participants, sends to each member a mail in which the text has insertion of a comment [The event on the o-th day in the o-th month will be held as scheduled.], and sends, as the condition 2 is met if there are three or more persons who do not participate, to each member a mail in which the text has insertion of a comment [The event on the o-th day in the o-th month is canceled.].

Thus, according to the modified example 1, the mail showing whether the event is held or not can be automatically sent to each member, depending on whether a necessary number of participants for the event assemble or not.

Note that if the key person is absent also in this modified example 1, the conditions may be set so that the event is canceled.

Further, in the modified example 1, the server, at the point of time when the number of participants or non-participants giving the answers received reaches “3”, sends the mails corresponding to the answers, however, without being limited to this condition, a predetermined date/time (e.g., a time limit of the answer) and an event start date/time are inputted as the appointed meeting conditions, the number of the participants giving the answers received till this date and time is counted while the rest of the persons are counted as non-participants, and the mails may be sent corresponding to the number of those persons.

Moreover, if the event periodically takes place, a periodic notification of the query mail in the modified example 1 may also be given corresponding to the event to be held.

### MODIFIED EXAMPLE 2

### Example of Communications for Appointed Meeting Place and Time

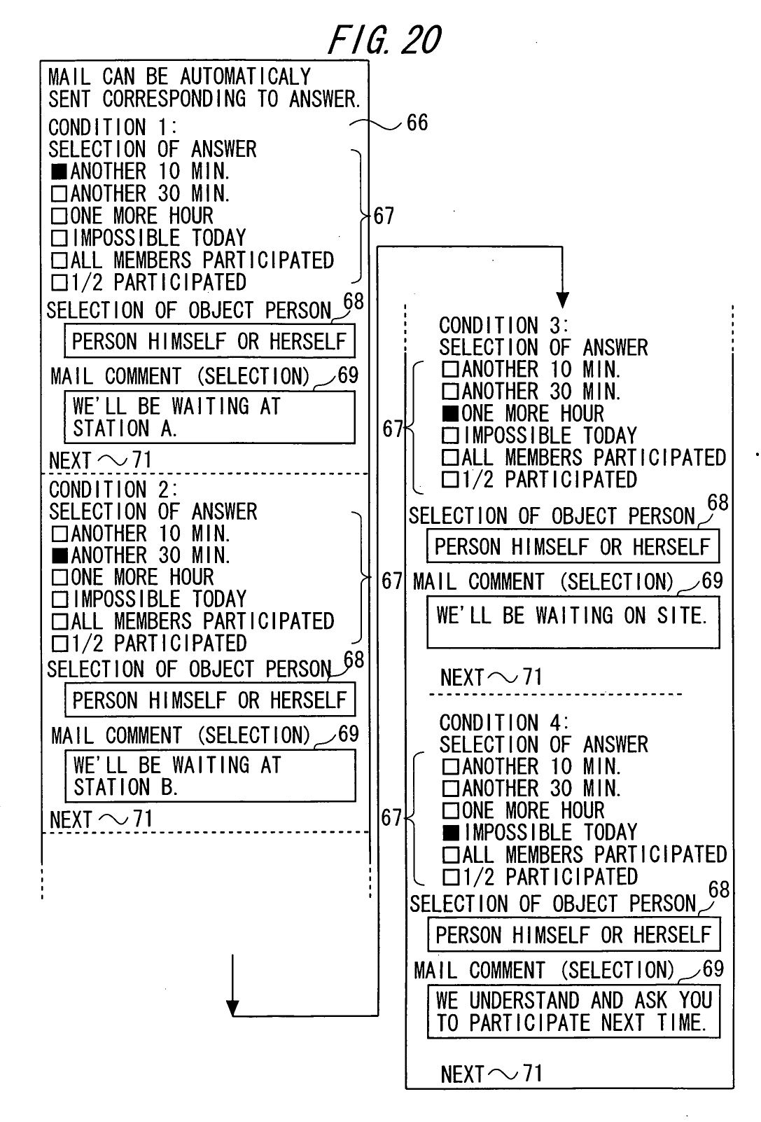

After selecting the answer item on the query condition setting page 61 in FIG. 9 in the same way as the above-mentioned, on a query condition setting page 66 in FIG. 20, a check box 67 for delay time (the time till the arrival) is selected, an appointed meeting place corresponding to this delay time is inputted into a comment box 69. Then, there is set a purport that this comment is transmitted to only the members concerned. For example, the person himself or herself is designated in an object person box 68, or alternatively an option (unillustrated) of a transmitting destination is separately provided and thus selected.

With this setting, the server 1 sends a mail having insertion of a comment [We'll be waiting at Station A.]to the cellular phone 2B of the member who answered “It will take another 10 minutes”, a mail having insertion of a comment [We'11 be waiting at Station B.] to the cellular phone 2B of the member who answered “It will take another 30 minutes”, a mail having insertion of a comment [We'll be waiting at the event place.]to the cellular phone 2B of the member who answered “It will take one more hour”, and a mail having insertion of a comment [We understand and expect your participation next time] to the cellular phone 2B of the member who answered “Impossible today”.

Note that the mail for notifying of the appointed meeting place thereof is sent to each member coincident with the appointed meeting condition in the modified example 2, however, without being limited to these members, the mail may also be transmitted to other members. For instance, in the case of receiving the answer “Impossible today” from the member having the address “s-tanaka@sky.net”, the appointed meeting condition may also be so set as to send a mail having insertion of a comment [Tanaka-san is impossible today] to other members.

Further, in the modified example 2, the delay time is received from the cellular phone 2B, however, without being limited to this delay time, a present location is received, a required period of time to reach the appointed meeting place is obtained in a way that refers to map information, etc., and a mail having insertion of a corresponding comment containing this required period of time set as the delay time may also be transmitted in the same way as the above-mentioned.

Thus, according to this modified example 2, it is possible to notify of the appointed meeting place corresponding to the delay time, and hence the participant with the delay can go to a proper place.

### MODIFIED EXAMPLE 3

### Example of Appointed Meeting for Golf Competition

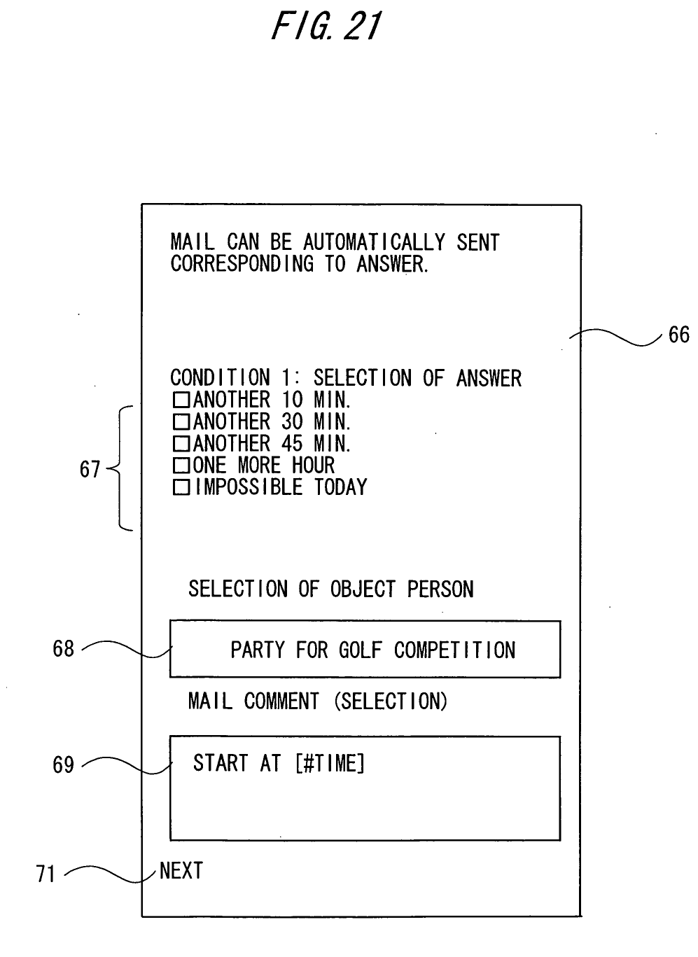

Similarly to the aforementioned, after selecting the answer item on the query condition setting page 61 in FIG. 9, on the query condition setting page 66 in FIG. 21, the start time corresponding to the delay time is inputted into a comment box 69. Then, there is set a purport that this comment is sent to every 3 or 4 members who will arrive with a delay. For example, a golf competition party is designated in the object person box 68, or options (unillustrated) for the transmitting destinations are separately provided and then selected.

With this setting, the server 1 notifies every 3 or 4 members of the changed start time in response to the answers given from the individual members. For instance, in a case where there are two members who answered “It will take another 30 minutes”, one member who answered “It will take another 45 minutes” and four members who answered “It will take one more hour”, the server 1 sends a mail having insertion of a comment [Golf competition starts at 7:45] to the three members with the delay of 30 through 45 minutes, and a mail having insertion of a comment [Golf competition starts at 8:00] to the four members with the delay of one hour.

Thus, according to the modified example 3, it is possible to notify of the start time corresponding to the delay time, and hence the participants with the delay can go to a golf course without anxiety.

<Others>

The invention is not limited to only the illustrated examples described above and can be, as a matter of course, changed in a variety of forms within the range that does not deviate from the gist of the invention.

### INCORPORATION BY REFERENCE

The disclosures of Japanese patent application No. JP2005-054801 filed on Feb. 28, 2005 including the specification, drawings and abstract are incorporated herein by reference.

What is claimed is:

1. A management device comprising:
a condition receiving module receiving member information about members making arrangements for an appointed meeting and appointed meeting conditions from an inquirer device;
a query module sending a member situation query message based on the member information to an inquired device;
a situation receiving module receiving member situation information from the inquired device;
an appointed meeting determining module obtaining the appointed meeting information on the basis of the situation information and the appointed meeting conditions; and
an appointed meeting communication module transmitting the appointed meeting information to the inquired device and the inquirer device.

2. A management device according to claim 1, wherein when the situation receiving module receives points of time till a plurality of members arrive as the situation information, the appointed meeting determining module determines, among the points of time till their arrivals, any one of the latest time, the latest time that does not exceed predetermined time, the time till an arrival of a predetermined member, the time when a predetermined number of members arrive and the time when a predetermined percentage of members arrive, as appointed meeting time.

3. A management device according to claim 1, wherein when the situation receiving module receives attendance and absence of the plurality of members as the situation information, the appointed meeting determining module determines to cancel or postpone the appointed meeting, with respect to the attendance and the absence of the members, if the situation information of the predetermined member is absence.

4. A management device according to claim 1, wherein when the situation receiving module receives the points of time till the plurality of members arrive and/or present locations as the member situation information, the appointed meeting determining module determines an appointed meeting place on the basis of the points of time till their arrivals.

5. An appointed meeting method by which a computer executes steps of:
receiving member information about members making arrangements for an appointed meeting and appointed meeting conditions from an inquirer device;
sending a member situation query message based on the member information to an inquired device;
receiving member situation information from the inquired device;
obtaining the appointed meeting information on the basis of the situation information and the appointed meeting conditions; and
transmitting the appointed meeting information to the inquired device and the inquirer device.

6. An appointed meeting method according to claim 5, wherein when receiving points of time till a plurality of members arrive as the situation information, among the points of time till their arrivals, any one of the latest time, the latest time that does not exceed predetermined time, the time till an arrival of a predetermined member, the time when a predetermined number of members arrive and the time when a predetermined percentage of members arrive, is determined as appointed meeting time.

7. An appointed meeting method according to claim 5, wherein when receiving attendance and absence of the plurality of members as the situation information, with respect to the attendance and the absence of the members, if the predetermined member is absent, the appointed meeting is determined to be canceled or postponed.

8. An appointed meeting method according to claim 5, wherein when receiving the points of time till the plurality of members arrive and/or their present locations as the member situation information, an appointed meeting place is determined based on the situation information.

9. An appointed meeting program for making a computer execute steps of:
receiving member information about members making arrangements for an appointed meeting and appointed meeting conditions from an inquirer device;
sending a member situation query message based on the member information to an inquired device;
receiving member situation information from the inquired device;
obtaining the appointed meeting information on the basis of the situation information and the appointed meeting conditions; and
transmitting the appointed meeting information to the inquired device and the inquirer device.

10. An appointed meeting program according to claim 9, wherein when receiving points of time as pieces of situation information till a plurality of members arrive, among the points of time till their arrivals, any one of the latest time, the latest time that does not exceed predetermined time, the time till an arrival of a predetermined member, the time when a predetermined number of members arrive and the time when a predetermined percentage of members arrive, is determined as appointed meeting time.

11. An appointed meeting program according to claim 9, wherein when receiving attendance and absence of the plurality of members as the situation information, with respect to the attendance and the absence of the members, if the predetermined member is absent, the appointed meeting is determined to be canceled or postponed.

12. An appointed meeting program according to claim 9, wherein when receiving the points of time till the plurality of members arrive and/or their present locations as the member situation information, an appointed meeting place is determined based on the situation information.

13. An appointed meeting system including an inquirer device, an inquired device and a management device that are connected via a network,
the management device comprising:
a condition receiving module receiving member information about members making arrangements for an appointed meeting and appointed meeting conditions from an inquirer device;
a query module sending a member situation query message based on the member information to an inquired device;
a situation receiving module receiving member situation information from the inquired device;
an appointed meeting determining module obtaining the appointed meeting information on the basis of the situation information and the appointed meeting conditions; and
an appointed meeting communication module transmitting the appointed meeting information to the inquired device and the inquirer device,
the inquirer device comprising: a condition transmitting module transmitting the member information and the appointed meeting conditions to the management device,
the inquired device comprising:
a query receiving module receiving a member situation query message;
a situation transmitting module transmitting the member situation information to the management device; and
an appointed meeting information receiving module receiving the appointed meeting information.
